(19) United States
(12) Patent Application Publication
(10) Pub. No.: US 2010/0127854 A1
(43) Pub. Date: May 27, 2010

(54) Method and system for controlling home appliances based on estimated time of arrival

(76) Inventors: Richard Eric Helvick, Portland, OR (US); Steven A. Wade, JR., Portland, OR (US); Atsushi Ishii, Vancouver, WA (US); Narasimhan Parthasarathy, Vancouver, WA (US)

Correspondence Address: SHARP LABORATORIES OF AMERICA, INC., 1320 PEARL ST., SUITE 228, BOULDER, CO, 80302, US

(21) Appl. No.: 12/313,532

(22) Filed: Nov. 21, 2008

(51) Int. Cl. G08B 1/08

(52) U.S. Cl. 340/539.14

(57) ABSTRACT

A method and system for automatically controlling home appliances based on an estimated time of arrival (ETA) of a resident at his or her home. In one aspect of the invention, a system for controlling a home appliance comprises a mobile electronic device (MED) and a home automation system (HAS), wherein the MED determines that a homeward bound condition is met and in response to determining that the homeward bound condition is met commences reporting whereby the HAS acquires ETA information for a resident based in part on device location information acquired by the MED, and wherein the HAS determines based in part on the ETA information that an ETA condition is met and in response to determining that the ETA condition is met executes a control action that controls the home appliance.

### BACKGROUND OF THE INVENTION

The present invention relates to home automation methods and systems and, more particularly, to a method and system for automatically controlling home appliances based on an estimated time of arrival of a resident at his or her home.

Home automation systems that automatically control home appliances, such as climate control systems, lighting systems, security systems and sprinkler systems, are known. Automatic control of home appliances in such home automation systems typically involves transitioning such appliances between a powered and unpowered state, between a fully powered state and power-conserving state, or between an active and inactive state. For example, a resident of a home may program a home automation system to have an air conditioning system powered-on when the resident is home and powered-off when the resident is away, or to have an alarm system disabled when the resident is home and enabled when the resident is away.

Unfortunately, the mechanisms used by known home automation systems to control home appliances are limited. One commonly supported control mechanism is a program schedule. Using this mechanism, a resident may configure a schedule for the home automation system to follow in controlling home appliances wherein the schedule comports with the resident's expectations about times that he or she will be at home. For example, if a resident routinely leaves home for work at 7 a.m. and returns home from work at 7 p.m., the resident may instruct the home automation system to turn-off a heating system at 7 a.m. and turn-on the heating system at 7 p.m. A significant problem with program schedules, however, is that the resident's expectations about when he or she will be home may substantially depart from reality due to, for example, after work social engagements. Another problem with program schedules is that the resident must change them whenever the resident's expectations about when he or she will be home change due to, for example, a job change, workshift change or vacation.

Another control mechanism used by some known home automation systems is presence detection. Using this mechanism, one or more sensors (e.g. motion detectors) at the house detect when the resident is home and take the control action in response to the detection. One problem with most presence detection mechanisms is that they do not confirm the identity of the person detected. Thus, an unauthorized person, such as a trespasser, may trigger a control action that puts the resident or his or her property at risk. Another problem with presence detection mechanisms is that they cannot take early control actions in anticipation of the later arrival of the resident. For example, a resident may desire to have an air conditioning system, heating system or oven turned-on several minutes in advance of the resident's arrival at home so that a desired temperature will be reached by the time the resident arrives home. In another example, a resident may desire to have an audio/visual (A/V) recording system activated several minutes in advance of the resident's arrival at home so that the resident can rewind and watch an in-progress television program from the beginning after arriving at home. Since presence detection mechanisms rely on physical presence at home to trigger control actions, these mechanisms are not able to take such anticipatory control actions.

### SUMMARY OF THE INVENTION

The present invention, in a basic feature, provides a method and system for automatically controlling home appliances based on an estimated time of arrival (ETA) of a resident at his or her home.

In one aspect of the invention, a system for controlling a home appliance comprises a mobile electronic device and a home automation system, wherein the home automation system acquires estimated time of arrival information for a resident using device location information acquired by the mobile electronic device, and wherein the home automation system determines using the estimated time of arrival information that an estimated time of arrival condition is met and in response to determining that the estimated time of arrival condition is met executes a control action that controls the home appliance.

In some embodiments, the mobile electronic device determines that a homeward bound condition is met and in response to determining that the homeward bound condition is met commences reporting whereby the home automation system acquires the estimated time of arrival information using the device location information.

In some embodiments, in response to determining that the homeward bound condition is met the mobile electronic device reports the device location information to the home automation system whereupon the home automation system acquires the estimated time of arrival information.

In some embodiments, in response to determining that the homeward bound condition is met the mobile electronic device acquires the estimated time of arrival information and reports the estimated time of arrival information to the home automation system.

In some embodiments, in response to determining that the homeward bound condition is met the mobile electronic device reports the device location information to an online service and the online service acquires the estimated time of arrival information and reports the estimated time of arrival information to the home automation system.

In some embodiments, the homeward bound condition is met based on a determination that the mobile electronic device is traversing a route that has previously led to a home identified by home location information configured on the mobile electronic device.

In some embodiments, the homeward bound condition is met based on a user input on the mobile electronic device indicating that the resident is homeward bound.

In some embodiments, the homeward bound condition is met based on a determination that the mobile electronic device has been progressing toward a home identified by home location information configured on the mobile electronic device for longer than a threshold time configured on the mobile electronic device.

In some embodiments, the estimated time of arrival information comprises a time estimate to travel on a roadway from a device location identified in the device location information to a home identified by configured home location information.

In some embodiments, the mobile electronic device acquires the device location information based at least in part on Global Positioning System signals.

In some embodiments, the estimated time of arrival condition is met in response to a determination that the time estimate is shorter than a configured estimated time of arrival.

In some embodiments, the home automation system notifies the mobile electronic device in response to executing the control action whereupon the mobile electronic device ceases reporting.

In some embodiments, the home appliance comprises a climate control system.

In some embodiments, the home appliance comprises a food preparation system.

In some embodiments, the home appliance comprises an audio/visual recording system

In some embodiments, the home appliance comprises a security system.

In some embodiments, the resident configures home location information, a homeward bound condition and a reporting frequency on the mobile electronic device.

In some embodiments, the resident configures the estimated time of arrival condition and the control action on the home automation system.

In another aspect of the invention, a method for controlling a home appliance comprises the steps of acquiring estimated time of arrival information for a resident using mobile electronic device location information, determining using the estimated time of arrival information that an estimated time of arrival condition is met and executing in response to determining that the estimated time of arrival condition is met a control action that controls the home appliance.

In some embodiments, the method further comprises the steps of determining that a homeward bound condition is met and commencing reporting in response to determining that the homeward bound condition is met whereby the estimated time of arrival information is acquired.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which the present invention may be implemented in some embodiments.

FIG. 2 shows the mobile electronic device of FIG. 1 in more detail.

FIG. 3 shows the home automation system of FIG. 1 in more detail.

FIG. 4 shows a method for configuring a system for controlling home appliances based on estimated time of arrival of a resident at his or her home in some embodiments of the invention.

FIG. 5 shows a method for controlling home appliances based on estimated time of arrival of a resident at his or her home in some embodiments of the invention.

### DETAILED DESCRIPTION OF A PREFERRED EMBODIMENT

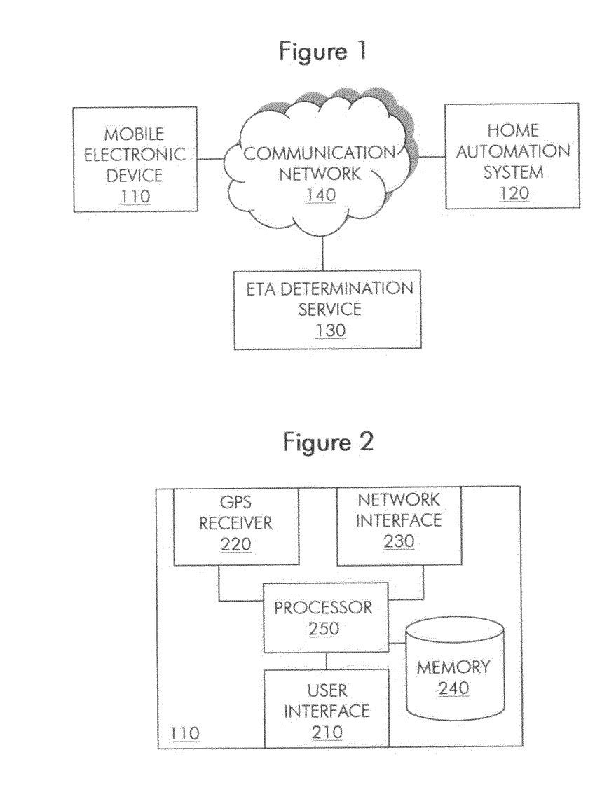

FIG. 1 shows a communication system in which the present invention may be implemented in some embodiments. The communication system includes a mobile electronic device (MED) 110, a home automation system (HAS) 120 and an estimated time of arrival (ETA) determination service 130, all of which are communicatively coupled via a communication network 140.

MED 110 is a network capable portable computing device, such as a cell phone, notebook computer, personal data assistant (PDA) or Internet appliance, for example, that is possessed by a resident who lives in a home that has one or more home appliances that are automatically controllable by HAS 120.

HAS 120 is a network capable computing device that is accessible by the resident and automatically controls one or more home appliances. In some embodiments, HAS 120 is located in the home where the resident lives and the automatically controlled home appliances reside.

ETA determination service 130 is a network capable service that determines an ETA of the resident at home using device location information supplied by MED 110 that identifies the present location of MED 110 and home location information supplied by HAS 120 that identifies the location of the home. In some embodiments, ETA determination service 130 is an online service hosted on one or more web servers. ETA determination service 130 in some embodiments has a map database with a map of roadways, a route calculator that determines one or more likely routes over roadways from the device location identified by the device location information and the home location identified by the home location information, a traffic assessor that determines traffic conditions along such routes and an ETA calculator that determines ETA of the resident at home based on traversal of such routes. While ETA determination service 130 is shown as a standalone element, in some embodiments all or part of ETA determination service 130 may be disposed on MED 110 and/or HAS 120. Where the ETA determination service is resident on MED 110 or HAS 120, the ETA determination service may be accessed via a local interface, such as a peripheral component interconnect (PCI) bus, or shared memory.

Communication network 140 is a data communication network that may include one or more wired or wireless local area networks (LANs), wide area networks (WANs), metropolitan area networks (MANs), cellular networks, ad-hoc and/or other networks, each of which may have one or more data communication nodes, such as switches, routers, bridges and/or hubs, operative to communicatively couple MED 110, HAS 120 and ETA determination service 130. Communication network 140 in some embodiments traverses the Internet.

FIG. 2 shows MED 110 in more detail. MED 110 has a user interface 210, a GPS receiver 220, a network interface 230 and a memory 240, all of which are communicatively coupled with a processor 250.

User interface 210 has an input mechanism, such as a keyboard, keypad, touch screen or voice command module for accepting inputs from the resident who possesses MED 110 and an output mechanism, such as a liquid crystal display (LCD) panel or light emitting diode (LED) display panel for displaying outputs to the resident.

GPS receiver 220 receives signals from GPS satellites and transmits device location information based on GPS signals to processor 250. In some embodiments, rather than acquiring device location information from a GPS source, MED 110 acquires device location information from access nodes in communication network 140 with which MED 110 establishes wireless links and which provide statically configured nodal position information.

Network interface 230 transmits and receives information on wireless links established with access nodes in communication network 140. Network interface 230 may be, for example, a wireless LAN (e.g. Wi-Fi) interface or a cellular network interface.

Memory 240 includes one or more random access memory (RAM) and one or more read-only memory (ROM) elements. Memory 240 stores software executable by processor 250 and user preferences. User preferences include home location information, a homeward bound condition and a reporting frequency configured by the resident. A default homeward bound condition and default reporting frequency may be used in the absence of configuration by the resident.

Processor 250 executes software installed in memory 240 to configure MED 110 and carry-out operations on MED 110 including determining when a homeward bound condition is met, and in response to determining that a homeward bound condition is met, commencing reporting whereby HAS 120 acquires ETA information for the resident using device location information acquired by MED 110.

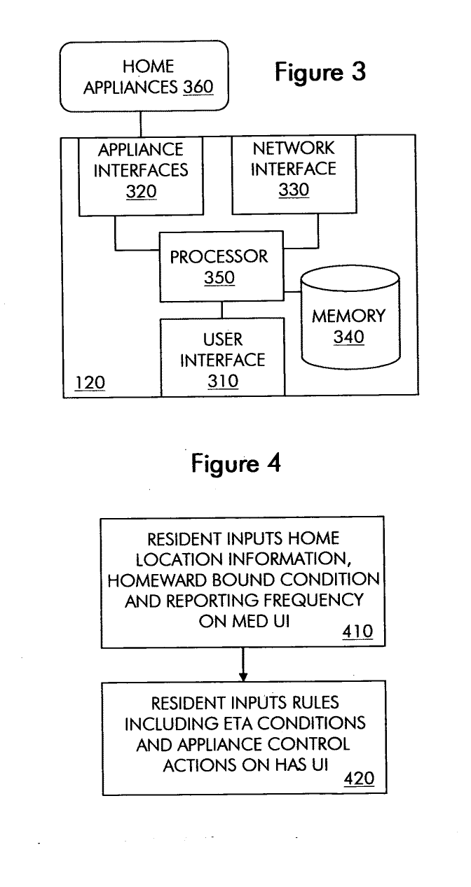

FIG. 3 shows HAS 120 in more detail. HAS 120 has a user interface 310, one or more appliance interfaces 320, a network interface 330 and a memory 340, all of which are communicatively coupled with a processor 350.

User interface 310 has an input mechanism, such as a keyboard, keypad, touch screen or voice command module for accepting inputs from the resident and an output mechanism, such as a LCD panel or LED display panel for displaying outputs to the resident.

Appliance interfaces 320 receive control instructions from processor 350 and control one or more home appliances 360, respectively, in response to control instructions. Appliance interfaces 320 in response to control instructions transition home appliances 360 between a powered and unpowered state, a fully powered state and power-conserving state (e.g. “sleep” state) or an active and inactive state, by way of example.

Network interface 330 may be, for example, a wireless LAN (e.g. Wi-Fi) interface or a cellular network interface.

Memory 340 includes one or more RAM and one or more ROM elements. Memory 340 stores software executable by processor and one or more control rules. Each control rule includes an ETA condition and an appliance control action.

Processor 350 executes software installed in memory 340 to configure HAS 120 and carry-out operations on HAS 120 including determining based in part on ETA information when an ETA condition is met, and in response to determining that the ETA condition is met, executing a control action by which one of home appliances 360 is controlled via one of appliance interfaces 320.

Home appliances 360 are controlled systems disposed at or near the resident's home and may include, for example, a climate control system (e.g. air conditioner, heater), food preparation system (e.g. oven), A/V recording system (e.g. digital TV recorder/player) and/or security system. Home appliances 360 are automatically controlled by HAS 120.

FIG. 4 shows a method for configuring a system for controlling one or more home appliances 360 based on ETA of the resident at home in some embodiments of the invention. Configuration of the system involves manual configuration by the resident of MED 110 and HAS 120. With regard to configuration of MED 110, the resident inputs on user interface 210 home location information, a homeward bound condition and a reporting frequency (410). Home location information may be, for example, a home address or geoposition (i.e. latitude and longitude) of the home. A homeward bound condition is a condition monitored on MED 110 that, when met, triggers periodic reporting by MED 110 whereby HAS 120 acquires ETA information that provides an estimate of when the resident will arrive at home. For example, a determination that a homeward bound condition is met may involve discovery by MED 110 that the resident is presently traversing a route that has led home three times in the past seven days. Or such a determination may involve an indication input by the resident on user interface 210 of MED 110 that the resident is homeward bound. Or such a determination may involve discovery by MED 110 that the resident has been progressing toward home for longer than a threshold time configured on mobile electronic device 110, such as five minutes. A reporting frequency is the frequency, such as five minutes, at which MED 110 reports information once the homeward bound condition has triggered reporting. The nature and destination of information reported by MED 110 depends upon how the system has been configured. The home location information, homeward bound condition and reporting frequency may be stored under control of processor 250 in a user preferences store within memory 240.

With regard to configuration of HAS 120, the resident inputs on user interface 310 one or more control rules including ETA conditions and control actions for home appliances 360 (420). An ETA condition is a condition monitored on HAS 120 that, when met, triggers a control action that controls one of home appliances 360. For example, a control rule may be configured that specifies an ETA condition “less than 45 minutes” and a control action “raise the temperature of heating system to 72 degrees.” When the ETA condition of less than 45 minutes is thereafter satisfied, a control action that raises the temperature of the home heating system to 72 degrees is executed. Taking additional examples, an ETA condition of less than five minutes may, when met, trigger a control action that turns on exterior home lighting. Or an ETA condition of less than one minute may, when met, trigger a control action that disables a home alarm system. Control rules are stored under control of processor 350 in memory 340. In some embodiments, a control rules list having multiple control rules is configured in memory 340.

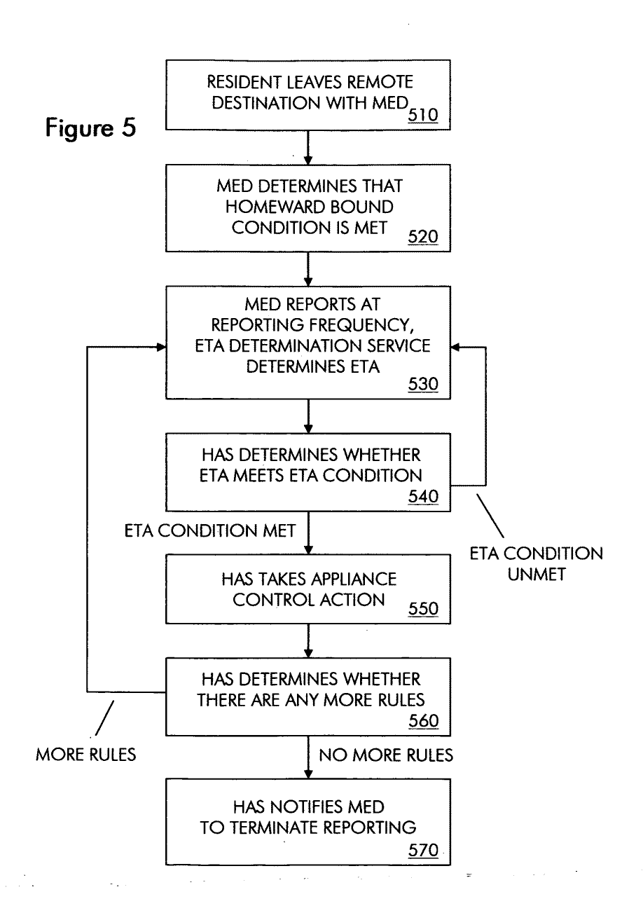

FIG. 5 shows a method for controlling one or more home appliances 360 based on an ETA of the resident at home in some embodiments of the invention. After configuring MED 110 and HAS 120, the resident leaves home for a remote destination (e.g. work) with MED 110 in his possession (510) and later leaves the remote destination and heads for home with MED 110 still in his possession.

On the way home, MED 110 continually monitors for a homeward bound condition and eventually determines that a homeward bound condition is met (520). For example, under control of processor 250, device location information acquired from GPS signals may be continually compared with one or more homeward bound routes stored in memory 240 until a homeward bound condition is identified from route similarities. Or the resident may input an explicit homeward bound indication on user interface 210. Or, under control of processor 250, device location information acquired from GPS signals may be continually compared with home location information configured in memory 240 until the progress made toward home is sufficient to trigger a homeward bound condition. In some embodiments, under control of processor 250, a reporting flag is set to “true” in memory 240 when a homeward bound condition is met to indicate that MED 110 has entered a reporting mode, and MED 110 consults the reporting flag to determine whether or not to report information.

Once a homeward bound condition is identified, MED 110 begins to report at the reporting frequency configured in memory 240 and ETA determination service 130 continually determines the resident's ETA at home (530). The nature of the reporting and ETA determinations varies in different embodiments. In some embodiments, under the control of processor 250, MED 110 reports to HAS 120 via network interfaces 230, 330 device location information determined from GPS signals and home location information configured in memory 240 in response to which, under the control of processor 350, HAS 120 acquires ETA information from an online ETA determination service 130. In these embodiments, under the control of processor 350, HAS 120 relays the device location information and home location information to ETA determination service 130 via network interface 330. ETA determination service 130 applies the device location information and home location information to a map database having a map of roadways and determines one or more likely routes over roadways from the device location identified by the device location information and the home location identified by the home location information, determines traffic conditions along the likely routes and determines an ETA of the resident at home based on traversal of the likely routes in light of traffic conditions. ETA determination service 130 then reports ETA information for one or more of the likely routes to HAS 120 via network interface 330. In some embodiments, ETA determination service also reports map and traffic information for the likely routes. In some embodiments, the home location information is configured in memory 340, such that the need for MED 110 to report home location information to HAS 120 is obviated.

In other embodiments, MED 110 acquires ETA information and reports the ETA information to HAS 120 via network interfaces 230, 330. In these embodiments, under the control of processor 250, MED 110 relays device location information determined from GPS signals and home location information configured in memory 240 to online ETA determination service 130 via network interface 230. ETA determination service 130 determines one or more likely routes over roadways from the device location identified by the device location information and the home location identified by the home location information, traffic conditions along the likely routes and an ETA of the resident at home based on traversal of the likely routes. ETA determination service 130 then reports ETA information for one or more of the likely routes to MED 110 via network interface 230. Under the control of processor 250, MED 110 then reports the ETA information to HAS 120 via network interfaces 230, 330.

In still other embodiments, MED 110 reports the device location information to online ETA determination service 130 and ETA determination service 130 acquires ETA information and reports the ETA information directly to HAS 120. In these embodiments, under the control of processor 250, MED 110 relays device location information determined from GPS signals and home location information configured in memory 240 to ETA determination service 130 via network interface 230. ETA determination service 130 determines one or more likely routes over roadways from the device location identified by the device location information and the home location identified by the home location information, traffic conditions along the likely routes and an ETA of the resident at home based on traversal of the likely routes. ETA determination service 130 then reports to HAS 120 via network interface 330 the ETA information for one or more of the likely routes.

Whenever HAS 120 acquires new ETA information, HAS 120 determines whether an ETA for the resident determined the ETA information meets an ETA condition (540). Consider, for example, a situation where a control rule stored in memory 340 specifies an ETA condition “less than 45 minutes” and an appliance control action “raise the temperature of heating system to 72 degrees,” and further where an ETA for the resident determined from the new ETA information is 43 minutes. In that event, under control of processor 350, HAS 120 determines that the ETA condition of the control rule is met and the flow advances to Step 550. On the other hand, if an ETA for the resident determined from the ETA information is 47 minutes, then under control of processor 350 HAS 120 determines that the ETA condition of the control rule is unmet and the flow returns to Step 530.

Whenever HAS 120 determines than an ETA condition of a control rule is met, HAS 120 executes the control action of the control rule to control via appliance interface 320 the one of home appliances 360 that is the subject of the control rule (550). Continuing with the above example, in response to determining that an ETA condition “less than 45 minutes” is met, under control of processor 350, HAS 120 controls a heating system via appliance interface 320 by adjusting the temperature to 72 degrees.

HAS 120 then determines whether any more control rules have unmet ETA conditions (560). For example, a second control rule stored in memory 340 may specify an ETA condition “less than one minute” and an appliance control action “disable alarm system.” In that event, under control of processor 350, HAS 120 determines that control rules remain that have unmet ETA conditions and the flow returns to Step 530. On the other hand, if no control rules remain with unmet ETA conditions, under control of processor 350, HAS 120 determines such and the flow advances to Step 570.

When HAS 120 determines that no control rules with unmet ETA conditions remain, HAS 120 notifies MED 110 to terminate reporting (570). In some embodiments, under control of processor 350, HAS 120 transmits to MED 110 via network interfaces 330, 230 a task completion notice, and under control of processor 250, MED 110 sets a reporting flag in memory 240 to “false” in response to the task completion notice to inhibit further reporting by MED 110.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A system for controlling a home appliance, comprising:
a mobile electronic device; and
a home automation system, wherein the home automation system acquires estimated time of arrival information for a resident using device location information acquired by the mobile electronic device, and wherein the home automation system determines using the estimated time of arrival information that an estimated time of arrival condition is met and in response to determining that the estimated time of arrival condition is met executes a control action that controls the home appliance.

2. The system of claim 1, wherein the mobile electronic device determines that a homeward bound condition is met and in response to determining that the homeward bound condition is met commences reporting whereby the home automation system acquires the estimated time of arrival information using the device location information.

3. The system of claim 2, wherein in response to determining that the homeward bound condition is met the mobile electronic device reports the device location information to the home automation system whereupon the home automation system acquires the estimated time of arrival information.

4. The system of claim 2, wherein in response to determining that the homeward bound condition is met the mobile electronic device acquires the estimated time of arrival information and reports the estimated time of arrival information to the home automation system.

5. The system of claim 2, wherein in response to determining that the homeward bound condition is met the mobile electronic device reports the device location information to an online service and the online service acquires the estimated time of arrival information and reports the estimated time of arrival information to the home automation system.

6. The system of claim 2, wherein the homeward bound condition is met based on a determination that the mobile electronic device is traversing a route that has previously led to a home identified by home location information configured on the mobile electronic device.

7. The system of claim 2, wherein the homeward bound condition is met based on a user input on the mobile electronic device indicating that the resident is homeward bound.

8. The system of claim 2, wherein the homeward bound condition is met based on a determination that the mobile electronic device has been progressing toward a home identified by home location information configured on the mobile electronic device for longer than a threshold time configured on the mobile electronic device.

9. The system of claim 1, wherein the estimated time of arrival information comprises a time estimate to travel on a roadway from a device location identified in the device location information to a home identified by configured home location information.

10. The system of claim 1, wherein the mobile electronic device acquires the device location information based at least in part on Global Positioning System signals.

11. The system of claim 9, wherein the estimated time of arrival condition is met in response to a determination that the time estimate is shorter than a configured estimated time of arrival.

12. The system of claim 2, wherein the home automation system notifies the mobile electronic device in response to executing the control action whereupon the mobile electronic device ceases reporting.

13. The system of claim 1, wherein the home appliance comprises a climate control system.

14. The system of claim 1, wherein the home appliance comprises a food preparation system.

15. The system of claim 1, wherein the home appliance comprises an audio/visual recording system

16. The system of claim 1, wherein the home appliance comprises a security system.

17. The system of claim 1, wherein the resident configures home location information, a homeward bound condition and a reporting frequency on the mobile electronic device.

18. The system of claim 1, wherein the resident configures the estimated time of arrival condition and the control action on the home automation system.

19. A method for controlling a home appliance, comprising the steps of;
acquiring estimated time of arrival information for a resident using mobile electronic device location information;
determining using the estimated time of arrival information that an estimated time of arrival condition is met; and
executing in response to determining that the estimated time of arrival condition is met a control action that controls the home appliance.

20. The method of claim 19, further comprising the steps of:
determining that a homeward bound condition is met; and
commencing reporting in response to determining that the homeward bound condition is met whereby the estimated time of arrival information is acquired.
